(19) United States
(12) Patent Application Publication
(10) Pub. No.: US 2003/0197485 A1
(43) Pub. Date: Oct. 23, 2003

(54) Battery adapter

(76) Inventors: Michael Miller, Mason City, IA (US); Michael Frank, Clear Lake, IA (US); Trent Bollman, Orchard, IA (US); Jay Miller, Mason City, IA (US)

Correspondence Address: KENYON & KENYON, ONE BROADWAY, NEW YORK, NY, 10004, US

(21) Appl. No.: 10/128,991

(22) Filed: Apr. 22, 2002

(51) Int. Cl. H02J 7/00

(52) U.S. Cl. 320/112

(57) ABSTRACT

A battery adapter having a base unit, a battery holder coupled to the base unit, the battery holder configured to receive a battery therein, and a circuit arrangement having a first connection arrangement, a second connection arrangement, a third connection arrangement and a processing arrangement, each of the first connection arrangement, the second connection arrangement and the third connection arrangement configured to receive power from an external power source and configured to provide said power to the processing arrangement, the processing arrangement configured to at least one of charge and discharge the battery.

### FIELD OF THE INVENTION

The present invention relates to a battery adapter for charging a battery.

### BACKGROUND INFORMATION

A conventional battery adapter is described in U.S. Pat. No. 5,818,197 and a battery adapter operable to connect to an external power source via two connection arrangements is described in U.S. Pat. No. 6,177,778. A battery adapter may be composed of a battery holder and a base unit. The battery holder is releasably coupled to the base unit for providing power to the battery adapter. When a battery is inserted into the battery holder, this battery is charged using the power received from the base unit. However, if the battery holder is removed from the base unit, the battery holder no longer receives power. Thus, the battery is not charged.

FIG. 11 shows an exemplary illustration of a conventional battery adapter 1100 for charging a battery 1105. The battery adapter 1100 includes a battery holder 1110, a base unit 1115 and a socket 1120. The battery holder 1110 is coupled to the base unit 1115. The socket 1120 is arranged on the base unit 1115 for providing power to the battery adapter 1100. The power is received from an external power source (not shown). The battery holder 1110 has a receptacle portion 1125 for receiving the battery 1105.

The battery 1105 can be inserted into the receptacle portion 1125 of the battery holder 1110 for charging and/or discharging the battery 1105. The receptacle portion 1125 has a first external surface 1130, and the battery 1105 has a second external surface 1135. The first external surface 1130 is suitably dimensioned to permit insertion of the battery 1105 into the receptacle portion 1125 of the battery holder 1110 via its second external surface 1135. The battery holder 1110 also includes a first holder contact 1140 and a second holder contact 1145. The first holder contact 1140 is provided for conductively coupling to a first battery contact 1150 of battery 1105, and the second holder contact 1145 is provided for conductively coupling to a second battery contact 1155 of the battery 1105. Contact locations (i.e., 1140, 1145, 1150, 1155) and quantity of contacts may vary. When the battery 1105 is lowered into the battery holder 1110 in a first direction 1160, the first and second holder contacts 1140, 1145 of the battery holder 1110 are electrically connected to the respective first and second battery contacts 1150, 1155 of the battery 1105. In this manner, the battery 1105 is either charged or discharged by the battery adapter 1100.

The socket 1120 can be either permanently coupled to the external power source or detachably connectable to a connection unit 1165 by inserting the connection unit 1165 into the socket in a second direction 1170. The connection unit 1165 is dimensioned to be inserted into the socket 1120 and maintained therein. When the connection unit 1165 is inserted into the socket 1120, the battery holder 1110 receives power which flows from the external power source and through an electrical cable 1175 to reach to the connection unit 1165. Power is then received at the socket 1120 of the battery holder 1110. Thus, the battery adapter 1100 receives power from the external unit, and utilizes this power to either charge or discharge the battery 1105.

FIG. 12 illustrates another conventional battery adapter 1200 for charging a battery 1205. The battery adapter 1200 shown in FIG. 12 includes a battery holder 1210 and a base unit 1215. The battery holder 1210 is connected to the base unit 1215 and has a receptacle portion 1220 for receiving a battery 1205. The receptacle portion 1220 of the battery holder 1210 can be pre-configured to receive various types of batteries (e.g., a nickel cadmium battery, a nickel metal-hydride battery, a lithium battery, etc.).

The battery 1205 can be inserted into the receptacle portion 1220 of the battery holder 1210 for charging and/or discharging the battery 1205. In particular, the battery 1205 is inserted into the receptacle portion 1220 of the battery holder 1210. The external portion 1225 of the battery 1205 has a smaller geometry than the geometry of an external surface 1230 of the battery holder 1210. Thus, the battery 1205 may be inserted into the receptacle portion 1220, for charging and/or discharging.

The battery adapter 1200 includes a first adaptor contact 1235 and a second adaptor contact 1240. The first and second adaptor contacts 1235, 1240 can be provided in the base unit 1215, in the battery holder 1210 or separately therebetween. The first adaptor contact 1235 is provided for conductively connecting to a first battery contact 1245 of the battery 1205, and the second adaptor contact 1240 is provided for conductively connecting to a second battery contact 1250 of the battery 1205. As the battery 1205 is lowered into the battery holder 1210 in a third direction 1255, the first and second adapter contacts 1235, 1240 of the battery adapter 1200 are electrically connected to the respective first and second battery contacts 1245, 1250 of the battery 1205. When the battery 1205 completes its charging procedure and/or a discharging procedure, the battery 1205 may be removed from the battery holder 1210 in the third direction 1255.

The battery adapter 1200 also includes a first electrical connector 1260 and one second electrical connector (e.g., a first electrically conductive groove 1265 and a second electrically conductive groove 1270). The first electrical connector 1260 may be an electrically conductive socket (which is similar to the socket 1120 shown in FIG. 11) and may be provided in the base unit 1215. The second electrical connector may include a first conductive groove 1265 and a second conductive groove 1270. Each of the first electrical connector 1260 and the second electrical connector 1265, 1270 can provide external power to the battery adapter 1200 from an external power source. Thus, the battery adapter 1200 can receive the external power, interchangeably, from the first electrical connector 1260 and/or from the second electrical connector 1265, 1270.

The first electrical connector 1260 can be either permanently coupled to the external power source or detachably connectable to a connection unit 1275 (which is coupled to a power source—not shown). When the connection unit 1275 is inserted into the first electrical connector 1260 in a fourth direction 1280, the battery adapter 1200 receives the external power, which flows from the connection unit 1275. A user may disconnect the connection unit 1275 from the first connector 1260 by removing the connection unit 1275 from the first connector 1260 in the fourth direction 1280, and thus interrupt the external power provided to the battery adapter 1200.

The second electrical connector 1265, 1270 receives power from a docking station 1285, which may have one or more bays, each for accommodating a separate battery adapter.

With the conventional battery adapters, it may not be possible to charge and/or discharge the battery using three different electrical connectors to allow each of the electrical connectors to provide power to the battery adapter.

### SUMMARY

An object of the present invention is to provide a battery adapter, having a base unit, a battery holder coupled to the base unit, the battery holder configured to receive a battery therein, and a circuit arrangement having a first connection arrangement, a second connection arrangement, a third connection arrangement and a processing arrangement, each of the first connection arrangement, the second connection arrangement and the third connection arrangement configured to receive power from an external power source and configured to provide said power to the processing arrangement, the processing arrangement configured to at least one of charge and discharge the battery.

Another object of the present invention is to provide a battery adapter of the type described above, in which at least one of the first connection arrangement, the second connection arrangement and the third connection arrangement is configured to electrically connect to a battery analyzer.

Yet another object of the present invention is to provide a battery adapter of the type described above, in which the circuit arrangement includes a reverse battery protection arrangement configured to disable an electrical connection between the battery and the circuit arrangement if the battery is improperly received within the battery holder.

Still another object of the present invention is to provide a battery adapter of the type described above, in which the circuit arrangement is further configured to electrically and logically receive data from the battery.

Yet another object of the present invention is to provide a battery adapter of the type described above, in which the circuit arrangement is further configured to detect a voltage of the battery, a current of the battery, a temperature of the battery, and/or a chemistry of the battery.

### BRIEF DESCRIPTION OF THE DRAWINGS

FIG. 1a is an illustration of an exemplary battery adapter according to the present invention.

FIG. 1b is a block diagram of an exemplary battery adapter according to the present invention.

FIG. 2a illustrates a side view of the exemplary battery adapter of FIG. 1a.

FIG. 2b illustrates a bottom view of the exemplary battery adapter of FIG. 1a.

FIG. 2c illustrates an exemplary first system for providing power from an external power source to the battery adapter.

FIG. 3a illustrates an exemplary second system for providing power from an external power source to the battery adapter of FIG. 1a via a docking station.

FIG. 3b illustrates the electrical connectivity between the docking station of FIG. 3a and the battery adapter of FIG. 1a.

FIG. 4a illustrates an exemplary third system for providing power from the external power source to the battery adapter of FIG. 1a via a battery analyzer.

FIG. 4b illustrates the electrical connectivity between the battery analyzer of FIG. 4a and the battery adapter of FIG. 1a.

FIG. 4c illustrates a battery analyzer system.

FIG. 5 illustrates a block diagram of an exemplary battery adapter according to the present invention operable to communicate data to and from an external device.

FIG. 6 illustrates further detail of an exemplary processing arrangement.

FIG. 7 illustrates an exemplary battery adapter operable to communicate with a smart battery.

FIG. 8 illustrates an exemplary user interface arrangement according to the present invention.

FIG. 9 is a schematic of an exemplary reverse battery protection arrangement according to the present invention.

FIG. 10 is a schematic of an exemplary circuit arrangement according to the present invention.

FIG. 11 illustrates a conventional battery adapter for charging a battery.

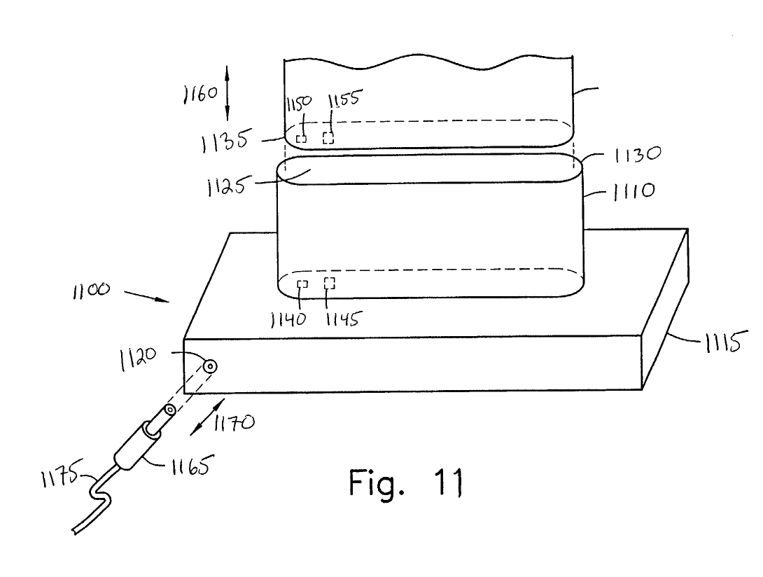

FIG. 12 illustrates another conventional battery adapter for charging a battery.

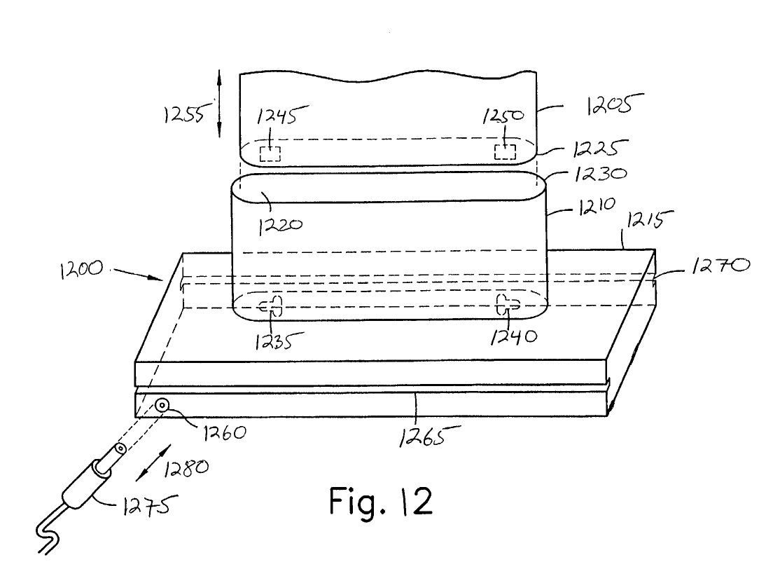

### DETAILED DESCRIPTION

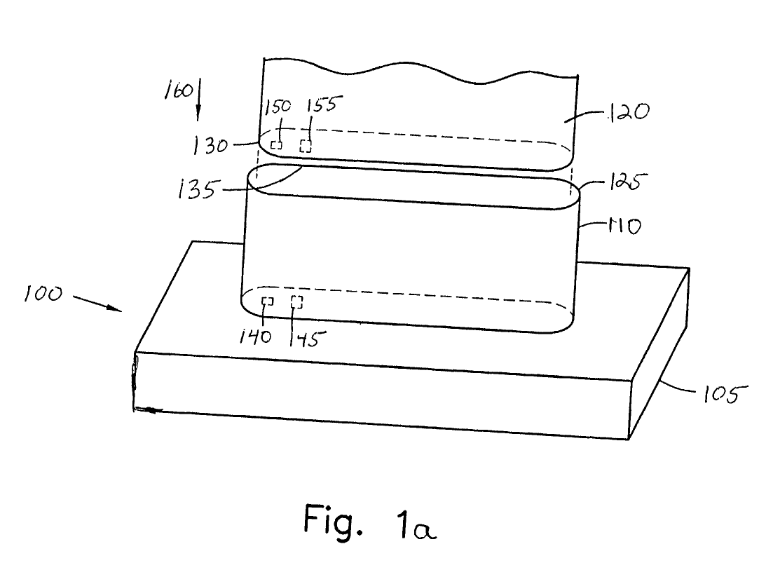

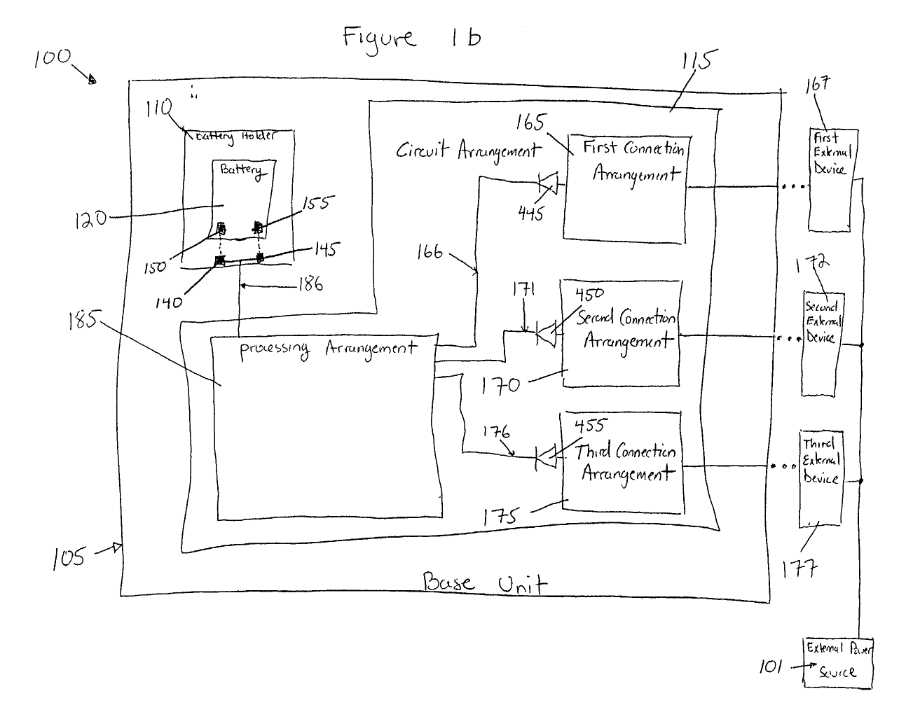

FIG. 1a illustrates an exemplary embodiment of a battery adapter 100 according to the present invention. Battery adapter 100 includes a base unit 105, battery holder 110, and a circuit arrangement (not shown). The battery holder 110 is connected to base unit 105 and has a receptacle portion 125 for receiving a battery 120. The receptacle portion 125 of the battery holder 110 may be pre-configured to receive various types of batteries, such as a nickel cadmium battery, a nickel metal-hydride battery, a lithium battery, etc.

As shown in FIG. 1a, the external surface 130 of the battery 120 has a smaller geometry than the geometry of an external surface 135 of the battery holder 110. Thus, the battery 120 may be inserted into the receptacle portion 125, for charging and/or discharging.

The battery adapter 100 includes a first adaptor contact 140 and a second adaptor contact 145. The first and second adaptor contacts 140, 145 may be provided, for example, in the base unit 105, in the battery holder 110 or separately therebetween. The first adaptor contact 140 is provided for conductively connecting to a first battery contact 150 of the battery 120, and the second adaptor contact 145 is provided for conductively connecting to a second battery contact 155 of the battery 120. As the battery 120 is lowered into the battery holder 110 in a first direction 160, the first and second adapter contacts 140, 145 of the battery adapter 100 electrically connect to the respective first and second battery contacts 150, 155 of the battery 120. When the battery 120 completes a charging procedure and/or a discharging procedure, the battery 120 may be removed from the battery holder 110.

FIG. 1b is a block diagram of an exemplary battery adapter 100 according to the present invention. As shown in FIG. 1b, the base unit 105 of the battery adapter 100 includes a circuit arrangement 115 and the battery holder 110. The circuit arrangement 115 includes a first connection arrangement 165, a second connection arrangement 170, a third connection arrangement 175, and a processing arrangement 185.

The battery adapter 100 may receive power from an external power source 101 via at least one of the first, second, and third connection arrangements 165, 170, 175. Each of the first, second, and third connection arrangements 165, 170, 175 is operable to receive power from the external power source 101 via a respective first, second, and third external device 167, 172, 177 (e.g., a docking station, a battery analyzer, etc.). Each of the first, second, and third connection arrangements 165, 170, 175 is also operable to provide said power to the processing arrangement 185 via first, second, and third power delivery connections 166, 171, 176, respectively. The processing arrangement 185 is electrically connected to the first and second adapter contacts 140, 145 by electrical connection 186. The processing arrangement is operable to at least charge and/or discharge the battery 120 when the battery 120 is inserted into the battery holder 110, whereby the first and second adapter contacts 140, 145 electrically contact the first and second battery contacts 150, 155, respectively.

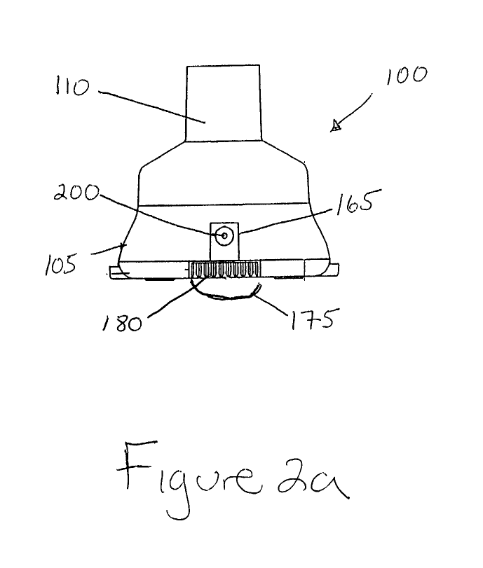

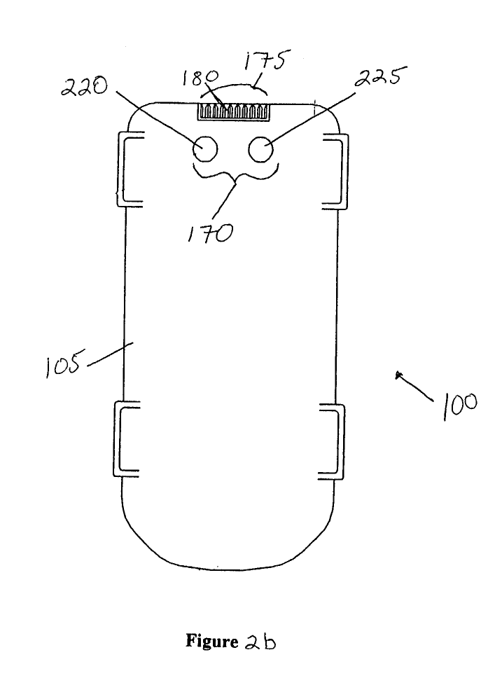

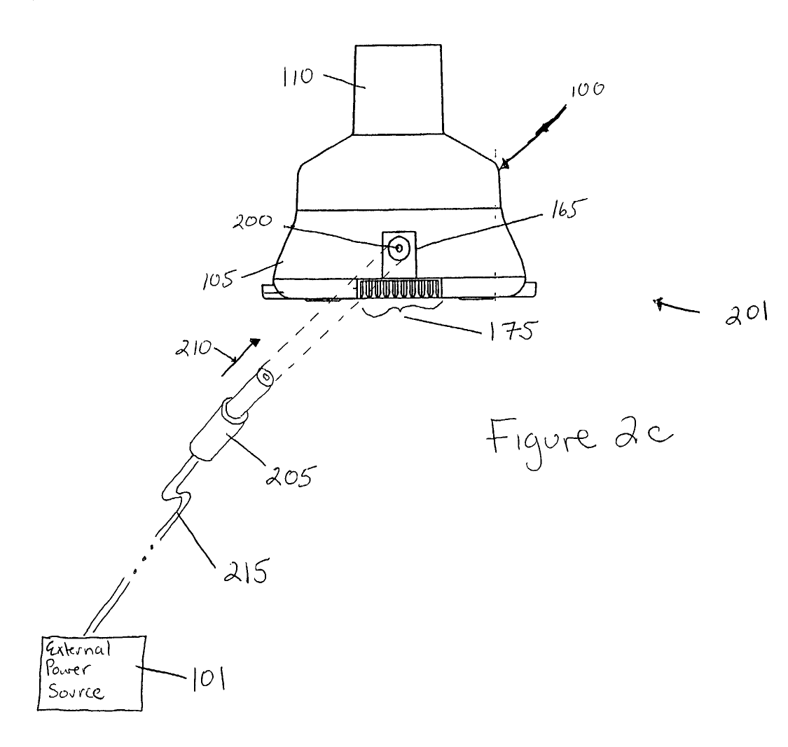

FIG. 2a illustrates a side view of the exemplary battery adapter 100 of FIG. 1a. FIG. 2a shows the first connection arrangement 165 including an electrically conductive socket 200 suitably configured to receive power from the external power source 101.

FIG. 2b illustrates a bottom view of the exemplary battery adapter 100 of FIG. 1a. FIG. 2b shows the second connection arrangement 170 including a first conductive rivet 220 and a second conductive rivet 225. The first and second conductive rivets 220, 225 are suitably configured to receive power from the external power source 101 and provide the power to the processing arrangement 185 of the battery adapter 100.

FIG. 2b also shows the third connection arrangement 175 including a plurality of conductive contacts 180. At least two of the plurality of conductive contacts 180 are suitably configured to receive power from the external power source 101 and provide the power to the battery adapter 100. The remaining ones of conductive contacts 180 may be used, for example, to facilitate data communication between the processing arrangement 185 and an external device and/or to permit the external device to charge and/or discharge the battery 120, as more fully described below.

It should be appreciated that, although FIG. 2b shows the third connection arrangement 175 including eight conductive contacts 180, the third connection arrangement 175 may include any number of conductive contacts suitable for connecting to the external device.

FIG. 2c illustrates an exemplary first system 201 for providing power from the external power source 101 to the battery adapter 100 via, for example, the first connection arrangement 165. The electrically conductive socket 200 of the first connection arrangement 165 may be permanently coupled to the external power source 101 or be detachably connectable to a connection unit 205 by inserting the connection unit 205 into the electrically conductive socket 200 in a second direction 210. The connection unit 205 is suitably dimensioned to be inserted into the electrically conductive socket 200 and maintained therein. When the connection unit 205 is inserted into the electrically conductive socket 200, the battery holder 110 receives power which flows from the external power source 101 and through an electrical cable 215 and into the connection unit 205. Power is then received at the electrically conductive socket 200. Thus, the battery adapter 100 receives power from the external power source 101, and utilizes this power, for example, to charge and/or discharge the battery 120.

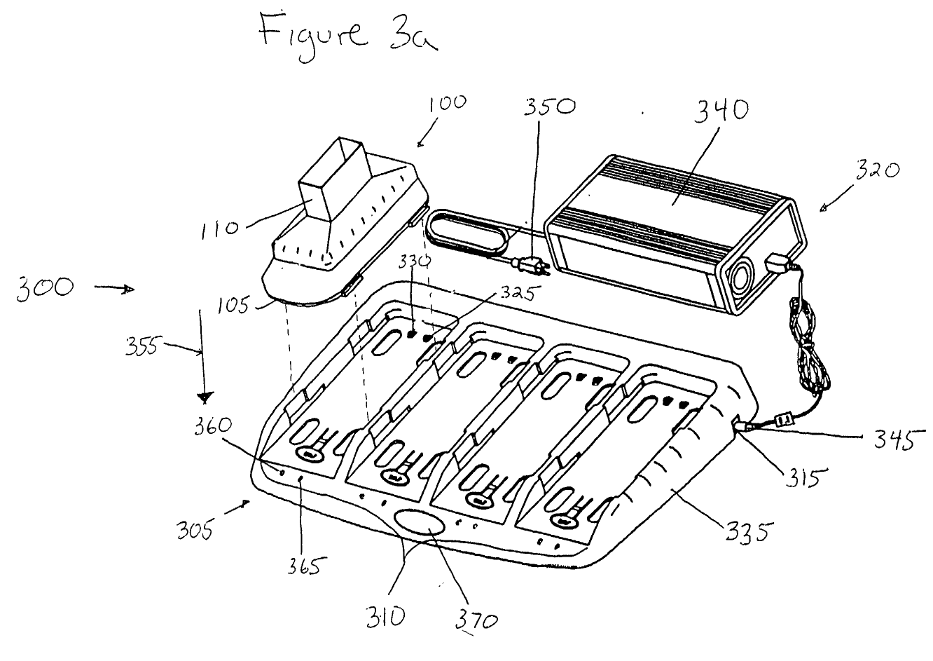

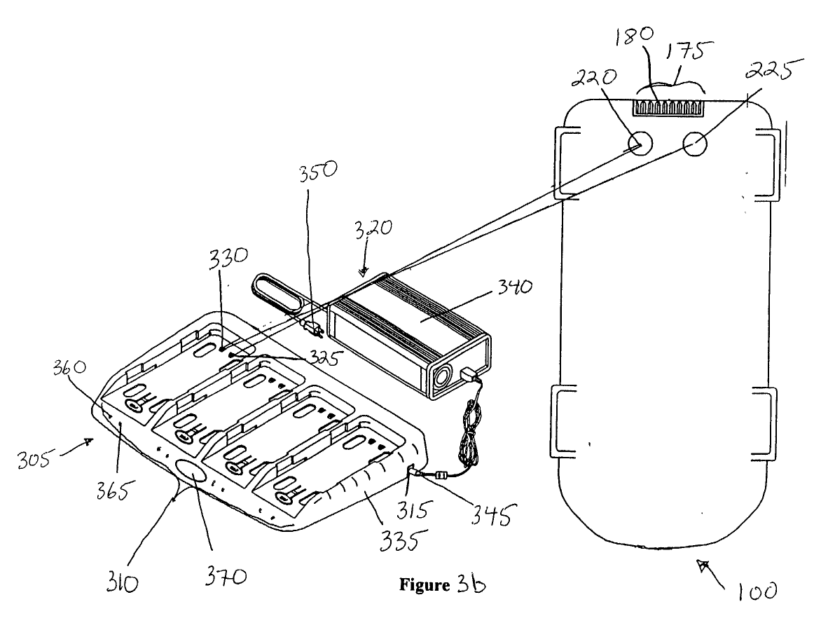

FIG. 3a illustrates an exemplary second system 300 for providing power from the external power source 101 to, for example, the second connection arrangement 170 of the battery adapter 100. Second system 300 includes a docking station 305, the battery adapter 100, and a power cable arrangement 320. Docking station 305 includes a base 335 having a plurality of ports 310, each of which is suitably dimensioned to receive a battery adapter 100. Each of ports 310 includes a first and a second reception contact 325, 330 for providing power to the battery adapter 100 via the first and second conductive rivets 220, 225, respectively. Docking station 305 also includes an electrically conductive socket 315 for receiving power from the external power source 101 via the power cable arrangement 320. The docking station 305 may also have a first indicator 360 (e.g., an LED), a second indicator 365 (e.g., an LED) and a first display device 370 (e.g., a liquid crystal display). These elements are associated with the operation of a respective one of the ports 310. For example, the first indicator 360 may be turned on when a selected one of the ports 310 is receiving power from the external power source 101 via the power cable arrangement 320, and turned off when the selected one of the ports 310 is no longer receiving power from the external power source 101. The second indicator 365 may be turned on when the battery adapter 100 is charging in the selected one of the ports 310, and turned off when the battery adapter 100 is removed from the selected one of the ports 310. The display device 370 may indicate the amount of power that is maintained by the battery 120 (which is situated in the battery holder 110 of the battery adapter 100).

The cable arrangement 320 includes a first connector 345 for providing power to the electrically conductive socket 315 and a second connector 350 for receiving power from the external power source 101 (not shown). The first connector 345 is suitably dimensioned to be received by the electrically conductive socket 315 for receiving power. The cable arrangement 320 may include a transformer 340 for AC/DC conversion of the power received from the external power source 101, if the external power source 101 supplies AC power.

It should be appreciated that the docking station may be provided AC power directly, which would obviate the need for the transformer 340. In this manner, transformer circuitry operable to convert AC power to DC power may be included in the docking station. Alternatively, the docking station may be provided with DC power directly from an external DC power source.

The battery adapter is lowered into a selected one of the ports 310 in a third direction 355, whereby the first and second reception contacts 325, 330 of the selected one of the ports 310 electrically contact the first and second conductive rivets 220, 225 of the battery adapter 100, respectively.

FIG. 3b illustrates the electrical connectivity between the docking station 305 of FIG. 3a and the battery adapter 100 (shown as a bottom view). As shown in FIG. 3b, the first conductive rivet 220 electrically connects to the first reception contact 325 and the second conductive rivet 225 electrically connects to the second reception contact 330.

Referring to FIGS. 3a and 3b, power is received from the external power source 101 by the power cable arrangement 320 and then channeled through the electrically conductive socket 315 to the first and second reception contacts 325, 330 of the selected one of the ports 310, thereby providing the power to the battery adapter 100 via the first and second conductive rivets 220, 225 of the second connection arrangement 170.

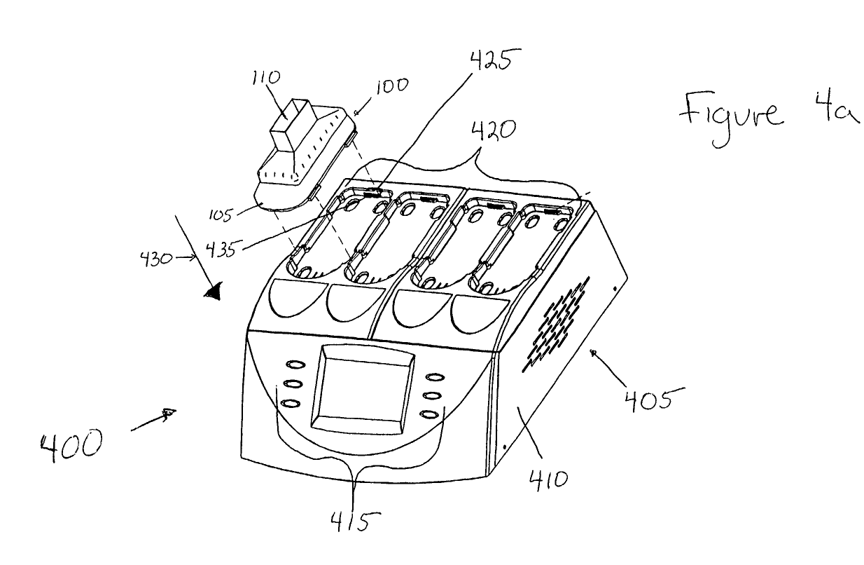

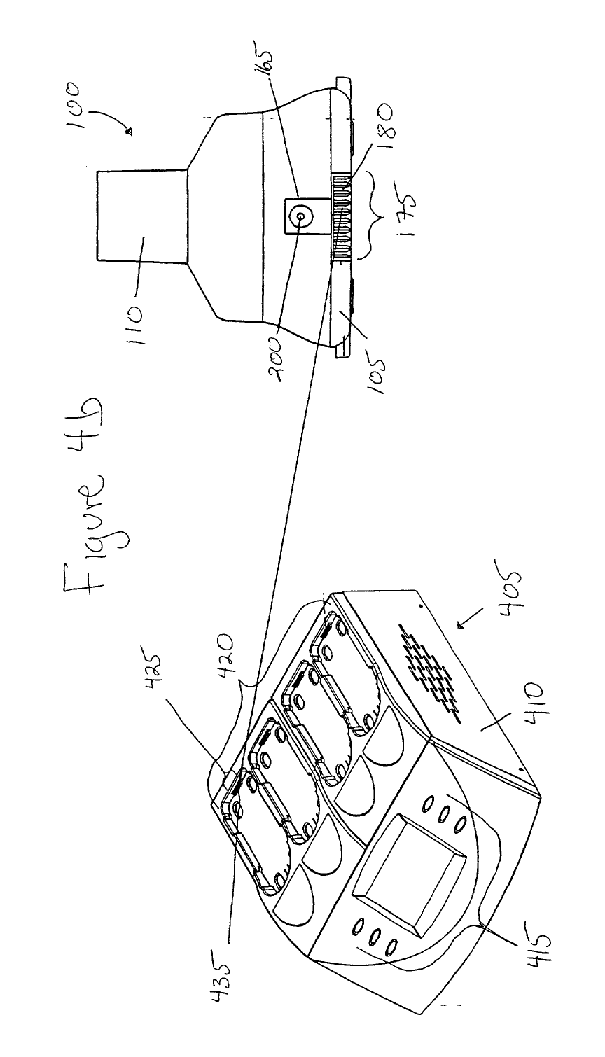

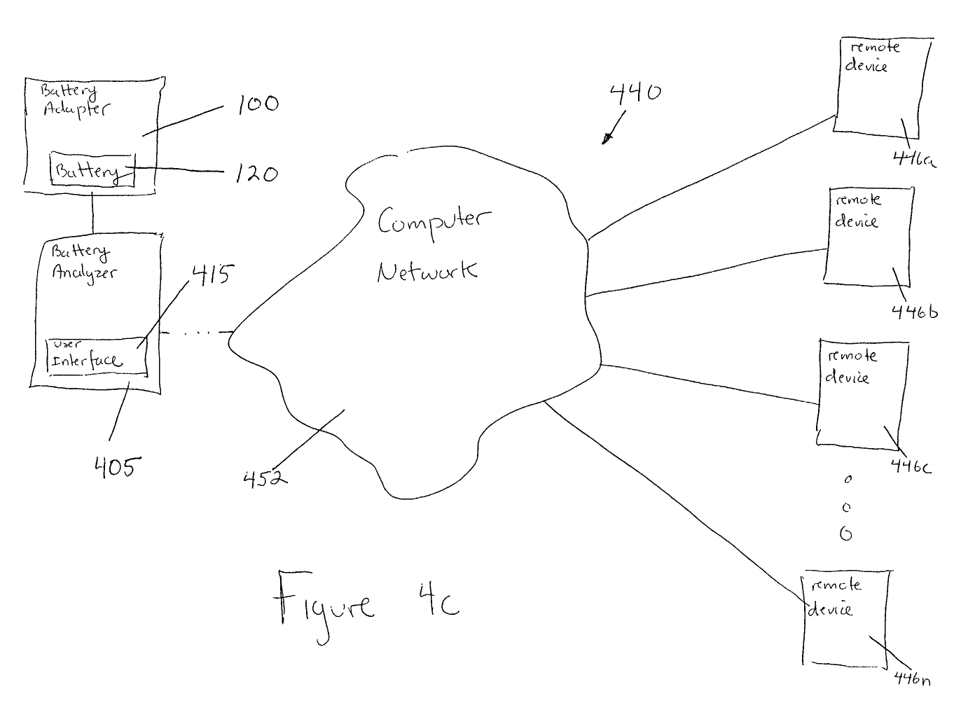

FIG. 4a illustrates an exemplary third system 400 for providing power from the external power source 101 to, for example, the third connection arrangement 175 of the battery adapter 100. Third system 400 includes a battery analyzer 405 and the battery adapter 100. Such a battery analyzer is described in U.S. Patent Application attorney docket No. 02520/49301, filed concurrently herewith and expressly incorporated herein by reference. The battery analyzer 405 is electrically connected to and receives power from the external power source 101 (not shown). The battery adapter 405 includes a base unit 410 having a user interface 415 and a plurality of ports 420.

The battery analyzer 405 may also be electrically connected to a computer network (not shown) for receiving information from a remote source, such as, for example, marketing and advertising information, which may be communicated to a user via the user interface 415.

The user interface 415 of the battery analyzer may also communicate status information to a user concerning at least one of the ports 420. For example, the user interface 415 may indicate whether a selected one of the ports 420 is receiving power from the external power source 101 and/or whether the battery adapter 100 is charging in the selected one of the ports 420. The user interface 415 may also indicate the amount of power that is maintained by the battery 120 (which is situated in the battery holder 110 of the battery adapter 100).

Each of the plurality of ports 420 of the battery analyzer 405 includes an analyzer connector 425 having a plurality of conductive contacts 435 for providing power to the battery adapter 100 via the conductive contacts 180 of the third connection arrangement 175.

The battery adapter 100 is lowered into a selected one of the ports 420 in a fourth direction 430, whereby the conductive contacts 435 of the battery analyzer 405 electrically contact the conductive contacts 180 of the battery adapter 100.

FIG. 4b illustrates the electrical connectivity between the battery analyzer 405 of FIG. 4a and the battery adapter 100. As shown in FIG. 4b, the conductive contacts 435 of the battery analyzer 405 electrically contact the conductive contacts 180 of the battery adapter.

Referring to FIGS. 4a and 4b, power is received from the external power source 101 and provided to the analyzer connector 425 of the selected one of the ports 420, thereby providing the power to the battery adapter 100 via the third connection arrangement 180.

In addition to facilitating power delivery to the battery adapter 100, at least some of the conductive contacts 180 of the third connection arrangement 175 may be used, for example, to facilitate data communication between the processing arrangement 185 and an external device, such as, for example, the battery analyzer 405.

Referring now to FIG. 4c, there is seen a battery analyzer system 440 according to the present invention. The battery analyzer system 440 includes a battery analyzer 405 having a user interface 415, at least one remote device 446a, 446b, 446c, . . . , 446n, a battery adapter 100 including at least one rechargeable battery 120, the battery adapter 100 being electrically coupled to the battery analyzer 405, and a computer network 452 communicatively coupled to the battery analyzer 405 and the at least one remote device 446a, 446b, 446c, . . . , 446n.

The computer network 452 may include any conventional arrangement operable to communicatively couple the battery analyzer 405 to the at least one remote device 446a, 446b, 446c, . . . , 446n, such as a dedicated point-to-point network, a token-ring network, a Wide Area Network (WAN), a Local Area Network (LAN), an intranet, an internet, and/or the Internet. Furthermore, each of the battery analyzer 405 and the at least one remote device 446a, 446b, 446c, . . . , 446n may be operable to communicatively couple to the computer network 452 by a hardwired connection (e.g., fiber optic cables and/or conductive cables) and/or by a wireless connection.

The battery analyzer 405 is operable to at least evaluate the battery 120 and to determine, for example, usage and performance information concerning the battery 120. The battery analyzer 405 may then communicate the usage and performance information, such as information indicating that the battery 120 is not performing correctly, to the at least one remote device 446a, 446b, 446c, . . . , 446n via the computer network 452. The battery analyzer 405 may also communicate data related to technical support, which may include charging and discharging parameters used in configuring a power management controller situated in the battery analyzer 405. The battery analyzer 405 is further operable to communicate user information, such as product order information, to the at least one remote device 446a, 446b, 446c, . . . , 446n in accordance with user input data received from a user via the user interface 415.

The at least one remote device 446a, 446b, 446c, . . . , 446n may include, for example, a respective centralized computer (not shown) operable to communicate remote information to the battery analyzer 405, such as marketing information, software updates for the battery analyzer 405 and/or the battery adapter 100, user manuals, technical support data, product catalog information, battery specifications data, and/or advertising information. The analyzer information may then be displayed to a user of the battery analyzer 405 via the user interface 415. Further, the marketing and/or advertising information may be generated in accordance with the usage and performance information concerning the battery 120 received from the battery analyzer 405. In this manner, the battery analyzer 405 and/or the at least one remote device 446a, 446b, 446c, . . . , 446n may inform the user, for example, when the battery 120 needs to be replaced or when the battery 120 is not operating properly.

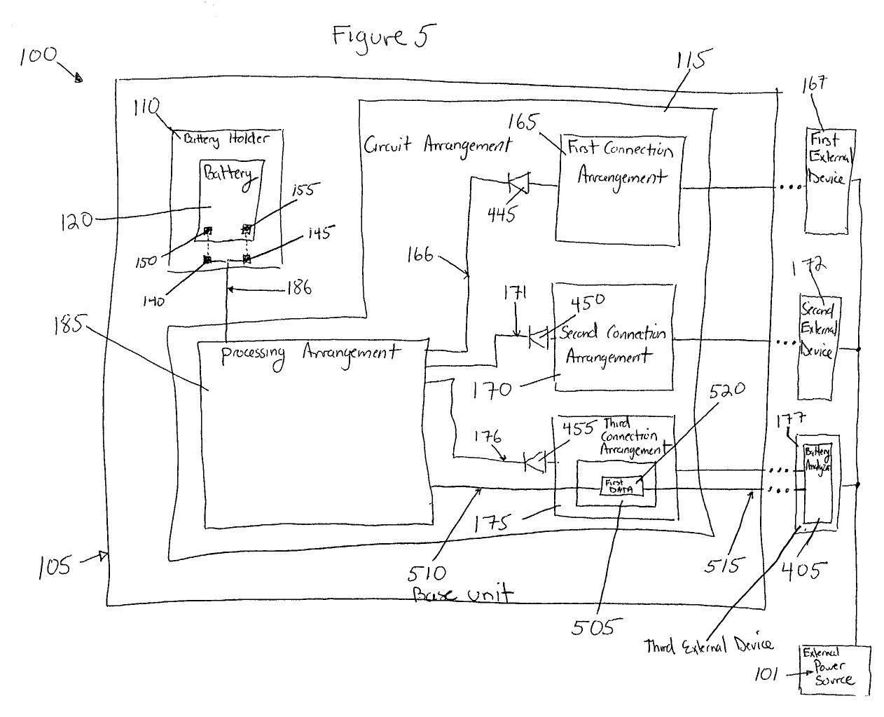

FIG. 5 illustrates a block diagram of an exemplary battery adapter 100 according to the present invention, in which the third connection arrangement is further operable to communicate data to and from the third external device 177, which may include, for example, the battery analyzer 405. As shown in FIG. 5, the third connection arrangement 175 includes a data communications arrangement 505 for facilitating data communication between the battery analyzer 405 and the processing arrangement 185. For this purpose, the data communications arrangement 505 is electrically and logically connected to both the processing arrangement 185 via first electrical connection arrangement 510 and the battery analyzer 405 via second electrical connection arrangement 515.

The data communications between the processing arrangement 185 and the battery analyzer 405 includes first data 520. First data 520 may include performance data of the battery 120, indicating a performance level of the battery 120 and/or reconfiguration data for reconfiguring, for example, a micro-computer of the processing arrangement 185, as more fully described below.

The battery analyzer 405 may also transmit and receive other information from the battery adapter 100 via the data communications arrangement 505. For example, the battery analyzer 405 may “ping” the battery adapter 100 to determine whether the battery adapter 100 is properly coupled to the battery analyzer 405. To “ping” the battery adapter 100, the battery analyzer 405 communicates a ping-message to the battery adapter 100 via the data communications arrangement 505 and waits for a reply. The absence of a reply indicates that the battery adapter 100 is either busy, not properly connected, or does not exist.

The battery analyzer 405 may also request status information from the battery adapter 100 via the data communications arrangement 505. For this purpose, the battery analyzer 405 communicates a status-request message to the battery adapter 100. The battery adapter 100 may then send the status information to the battery analyzer 405 via the data communications arrangement 505. The status information may indicate, for example, that the battery adapter 100 is waiting for the battery 120 to be inserted, that the battery 120 is fully charged, that the battery adapter 100 is waiting or is in a standby mode, that the battery adapter 100 has a fatal error that needs correcting, that the battery adapter 100 is currently charging the battery 120, that the battery adapter 100 is topping off the battery 120, and/or that the battery adapter 100 is discharging the battery 120.

The battery analyzer 405 may also read and/or write information to a memory device (not shown) situated in the battery adapter 100. For example, the battery analyzer 405 may read old program code (e.g., program code to be executed on a micro-computer in the battery adapter 100) from the memory device of the battery adapter 100 and/or may write new replacement program code to the memory device via the data communications arrangement 505.

To avoid overloading the first, second, and third connection arrangements 165, 170, 175 and to prevent any damage of the battery 120 and/or the battery adapter 100, the current provided by one of the first, second, and third connection arrangements 165, 170, 175 may be isolated from affecting the other ones of the first, second, and third connection arrangements 165, 170, 175. This may be achieved, for example, by connecting each of the first, second, and third connection arrangements 165, 170, 175 to a respective one of first, second, and third isolation diodes 445, 450, 455. Each of the first, second, and third isolation diodes prevents current from flowing back into the external power source 101.

It should be appreciated that the first, second, and third connection arrangements 165, 170, 175 may include other features in addition to or in lieu of those described above. For example, any of the first, second, and third connection arrangements 165, 170, 175 may be configured to connect to the electrical cable 215, the docking station 305 and/or the battery analyzer 405. Furthermore, more than one of the first, second, and third connection arrangements 165, 170, 175 may be configured to connect to the same type of device. For example, each of the first, second, and third connection arrangements 165, 170, 175 may be configured to connect to a respective docking station 305.

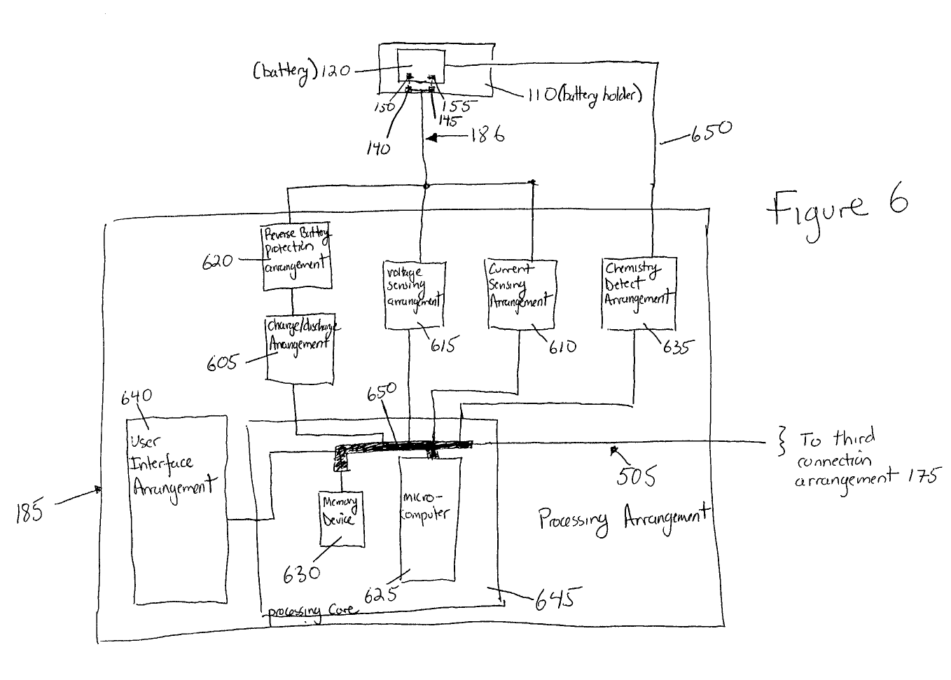

FIG. 6 illustrates further detail of the exemplary processing arrangement 185 shown in FIGS. 1b and 5. The processing arrangement 185 may include electrical circuitry situated, for example, on a single printed circuit board or, alternatively, may be situated on a plurality of circuit boards contained within the base unit 105. Processing arrangement 185 includes a charge/discharge arrangement 605, a current sensing arrangement 610, a voltage sensing arrangement 615, a user interface arrangement 640, and a chemistry detect arrangement 635, each of which is electrically connected to a processing core 645. The processing arrangement 185 also includes a reverse battery protection arrangement 620 electrically connected to the charge/discharge arrangement 605. Each of the current sensing arrangement 610, the voltage sensing arrangement 615, and the reverse battery protection arrangement 620 is electrically connected to the first and second adapter contacts 140, 145 via electrical connection 186. The first and second adapter contacts 140, 145 electrically contact the battery contacts 150, 155 of the battery 120, when the battery 120 is inserted into the battery holder 110. The chemistry detect arrangement 635 is electrically connected to the battery 120, for example, via a tri-state logic data line 650, as more fully described below.

In this exemplary embodiment, processing core 645 includes circuitry operable to control at least the charging and/or discharging of the battery 120 via the charge/discharge arrangement 605. FIG. 6 shows processing core 645 including a micro-computer 625 electrically and logically connected to a memory device 630. The memory device 630 may include any readable/writable memory device, such as, a Random Access Memory (RAM), FLASH, EEPROM, EPROM, CD-drive, mini-disk, floppy disk, hard disk, etc. The memory device 630 may store suitably configured program code for execution on the micro-computer 625 and/or other information, such as, for example, information relating to a charging status of the battery 120, information relating to a discharging status of the battery 120, information relating to a performance of the battery 120, etc. The micro-computer 625 and/or the memory device 630 are also electrically and logically connected to the data communications arrangement 505 of the third connection arrangement 175 (not shown) to permit an external device, such as the battery analyzer 405, to reconfigure the micro-computer 625 by loading replacement program code in the memory device 630 for execution on the micro-computer 625.

FIG. 6 shows each of the charge/discharge arrangement 605, the current sensing arrangement 610, the voltage sensing arrangement 615, the user interface arrangement 640, the chemistry detect arrangement ⁶³5, the memory device 630, and the data communications arrangement 505 electrically and logically connected to the micro-computer 625 via a data bus 650. However, it should be appreciated that other connection arrangements may be used in addition to or in lieu of the data bus 650. For example, each of the charge/discharge arrangement 605, the current sensing arrangement 610, the voltage sensing arrangement 615, the user interface arrangement 640, the chemistry detect arrangement 635, the memory device 630, and the data communications arrangement 505 may be connected to the micro-computer 625 using respective hardwired data lines (not shown).

As described above, the processing core 645 is operable to control the charging of the battery 120 via the charge/discharge arrangement 605. To initiate an efficient charging of the battery 120, the processing core 645 may use a combination of constant voltage control (CV) and constant current control (CC), in accordance with the chemistry of battery 120, such as, for example, nickel cadmium, nickel metal-hydride, lithium, etc. Each chemistry may utilize a unique combination of CV and CC control, that is, a unique charge profile. In CV control, the processing core 645 provides a constant voltage across the first and second battery contacts 150, 155 of the battery 120. The constant voltage applied depends on a desired final charging voltage of the battery 120. For example, if a user desires to charge battery 120 to 5 volts, CV control applies a constant voltage of 5 volts across the first and second battery contacts 150, 155 of the battery 120. If battery 120 is a fully uncharged battery, the constant voltage applied causes a large initial current to flow through (i.e., spike through) the first and second battery contacts 150, 155. To prevent the current from “spiking” during an initial charge, CC control may be employed to effectively limit the maximum amount of current fed to the charging battery 120. As the battery 120 charges, the voltage of the battery 120 approaches the constant voltage applied by the processing core 645, thereby causing the current flowing through the first and second battery contacts 150, 155 of the battery 120 to decrease. Once the battery 120 reaches the desired final charging voltage, for example, 5 volts, the current tapers to a predetermined level and the processing core ceases charging the battery 120.

The current sensing arrangement 610 and the voltage sensing arrangement 615 include circuitry operable for detecting the current and voltage across the first and second battery contacts 150, 155 of the battery 120, respectively. The current sensing arrangement 610 and the voltage sensing arrangement 615 communicate the sensed voltage and sensed current to the processing core 645 for use in generating a desired charge profile, as described above.

The chemistry detect arrangement 635 includes circuitry operable to detect the chemistry of the battery 120, such as, for example, a nickel cadmium battery, a nickel metal-hydride battery, a lithium battery, etc. The chemistry detect arrangement 635 may include electrical circuitry operable to connect to the tri-state logic data line 650, which may be provided by battery 120. Tri-state logic data line 650 includes three discrete logical states, e.g., “high,” “low,” and “float”. Each state may be used to communicate a different chemistry. For example, a “high” logic level may indicate that battery 120 is a nickel metal-hydride battery, a “low” may indicate that battery 120 is a nickel cadmium battery, and a “float” may indicate that battery 120 is a lithium battery. The chemistry detect arrangement 635 communicates the sensed chemistry of the battery 120 to the processing core 645 for use in generating a desired charge profile, as described above.

The processing core 645 may use the sensed current, the sensed voltage, and the sensed chemistry of the battery 120 to influence the charge profile of the battery 120. For example, if a fully discharged battery 120 is initially placed in the battery holder 110, the processing core may initially provide a CV control voltage that exceeds the desired final charging voltage. For example, if the user desires a final charging voltage of 5 volts, the processing core may initially provide a CV control voltage of 8 volts. Providing CV control in this manner causes the battery 120 to charge faster. As the voltage across the first and second battery contacts 150, 155 of the battery 120 approaches the desired final charging voltage, the processing core 645 may gradually reduce the CV control voltage to 5 volts, thereby preventing the battery 120 from charging to a voltage that exceeds the desired final charging voltage.

The processing core 645 may also influence the charge profile in accordance with the current flowing through the first and second battery contacts 150, 155 of the battery 120. For example, as the voltage across the first and second battery contacts 150, 155 approaches the desired final charging voltage, the current flowing through the first and second battery contacts 150, 155 decreases. During an initial charge of a fully discharged battery 120, the current flowing through the first and second battery contacts 150, 155 will be relatively high. The processing core 645 may, for example, raise the initial CV control voltage above the desired final charging voltage of the battery 120, while the current flowing through the first and second battery contacts 150, 155 is relatively high, and then gradually reduce the CV control voltage as the current flowing through the first and second battery contacts 150, 155 decreases.

The chemistry, sensed current, and sensed voltage of the battery 120 may also be used to initiate a condition cycle of the battery 120. A condition cycle may be required to compensate for battery memory, which causes some rechargeable batteries to hold less charge during a charging cycle if they are not discharged completely before being charged, or if a poorly designed battery charger continues to charge a battery after the battery is fully charged.

Two types of batteries that suffer from the effects of battery memory are Ni—Cd batteries and nickel metal hydride batteries, although nickel metal hydride batteries do not suffer from the effects of battery memory to the same extent as do Ni—Cd batteries.

Lithium ion batteries and lead acid batteries, for example, automobile batteries, are generally very reliable. Neither of these types of batteries suffer substantially from the effects of battery memory.

The negative effects of battery memory may be reduced by successive cycles of discharging and recharging the battery 120, for example, discharging and recharging the battery 120 three times. To determine battery memory, the battery adapter 100 may monitor the temperature of the battery 120 sometime after the battery adapter 100 fully charges the battery 120. The temperature of the battery may be sensed by a thermistor (not shown) situated in the battery adapter 100.

Based at least in part on the sensed current, sensed voltage, sensed chemistry, and sensed temperature of the battery 120, the processing core 645 of the battery adapter 100 may initiate a condition cycle via the charge/discharge arrangement 605.

The processing core 645 also includes circuitry operable to control the discharging of battery 120 via the charge/discharge arrangement 605. A discharging of the battery 120 may occur automatically, such as, for example, during a condition cycle, or may be initiated manually by a user via the user interface arrangement 640.

To initiate an efficient discharge of the battery 120, the charge/discharge arrangement 605 essentially short-circuits the battery contacts 150, 155 of the battery 120 to ground through a low-resistance conductive path. The lower the resistance of the path to ground, the faster the battery 120 will discharge. However, the faster the battery 120 discharges, the faster the battery 120 generates energy and heat. To prevent potentially damaging effects of the energy and heat, the battery adapter 100 may not discharge the battery 120 beyond a predetermined critical rate (i.e., the rate at which the generated energy and heat becomes potentially damaging to the battery adapter 100). To permit a faster discharge rate beyond the critical rate, the battery adapter 100 may discharge the battery 120 through the battery analyzer 405, since the battery analyzer 405 may include a large heat sink and/or fan (not shown) to better dissipate the energy and heat generated by the discharging battery 120.

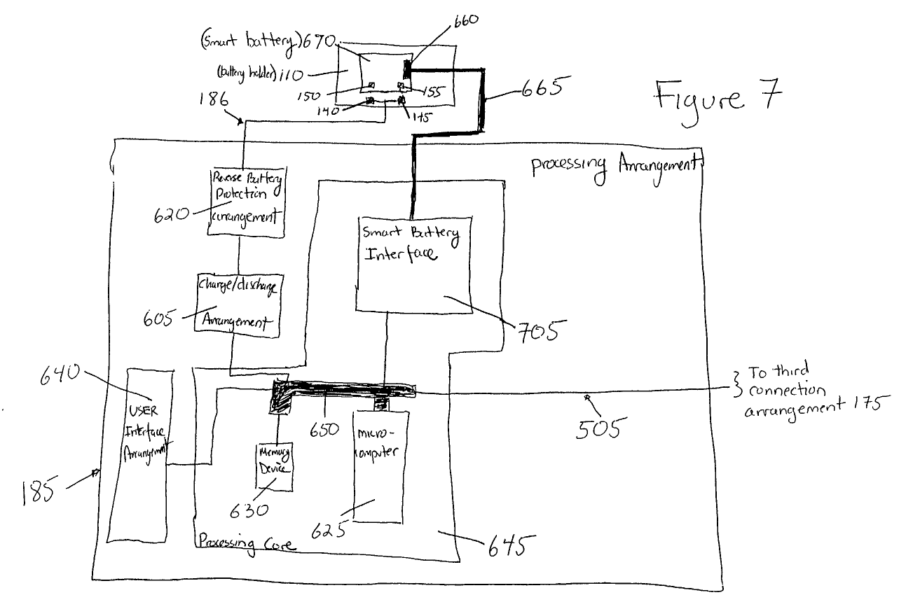

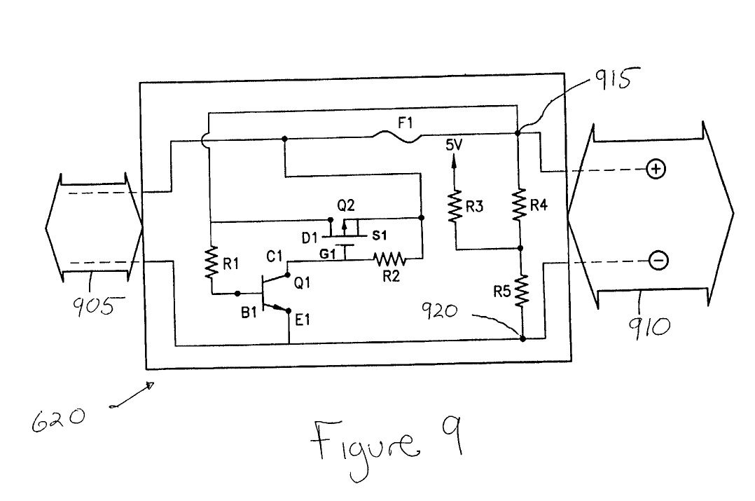

The processing arrangement 185 also includes a reverse battery protection arrangement 620. FIG. 9 shows an exemplary embodiment of the reverse battery protection arrangement 620 illustrated in FIGS. 6 and 7. The reverse battery protection arrangement 620 prevents the battery 120 from being damaged, such as, if the battery 120 is improperly inserted into the battery holder 110 (which may generate a short circuit, an overload, etc.). The reverse battery protection arrangement 620 may also prevent any such damage to the battery adapter 100. The reverse battery protection arrangement 620 is electrically connected to the battery charge/discharge arrangement 605 via a first connection arrangement 905. The reverse battery protection arrangement 620 also communicates with the battery 120 via a second connection arrangement 910. As illustrated in FIG. 9, the reverse battery protection arrangement 620 may include a first switch Q1, a second switch Q2, a first resistor R1, a second resistor R2 and a fuse F1. In an alternative embodiment, fuse F1 is not used, as the reverse battery protection features of the reverse battery protection arrangement 620 may provide sufficient protection without it.

The first adaptor contact 140 in the battery adapter 100 is conductively connected to, e.g., a first terminal 915 of the reverse battery protection arrangement 620. The second adaptor connector 145 in the battery adapter 100 is conductively connected to a second terminal 920 of the reverse battery protection arrangement 620. In this manner, the first terminal 915 is capable of contacting one of the first and second battery contacts 150, 155 of the battery 120, and the second terminal 920 is capable of contacting another one of the first and second battery contacts 150, 150 of the battery 120.

In operation, when the battery 120 is properly connected to the battery adapter 100 via the first and second battery contacts 150, 155 (e.g., the first battery contact 150 is electrically connected to the first terminal 915, and the second battery contact 155 is electrically connected to the second terminal 920), the first switch Q1 is turned on because the voltage at a terminal B1 of the first switch Q1 is higher than the voltage at a terminal E1. By turning on the first switch Q1, a terminal G1 enables the second switch Q2 (i.e., switches on the second switch Q2), and thus the current flows between a terminal D1 and a terminal S1 of the second switch Q2.

When the battery 120 is improperly connected to the battery adapter 100 via the first and second battery contacts 150, 155 (e.g., the first battery contact 150 is electrically connected to the second terminal 920, and the second battery contact 155 is electrically connected to the first terminal 915), the first switch Q1 is turned off because the voltage at the terminal B1 of the first switch Q1 is lower than the voltage at the terminal E1. Because the first switch Q1 is turned off, the second switch Q2 is also switched off, and thus the current is prevented from flowing between the terminal D1 and the terminal S1 of the second switch Q2.

As described above, the processing core receives the current, voltage, and chemistry of the battery 120 from the current sensing arrangement 610, the voltage sensing arrangement 615, and the chemistry detect arrangement 635, respectively. However, certain types of batteries, for example, “smart” batteries, include “smart” circuitry, capable of communicating digital information concerning the battery, such as current, voltage, and chemistry.

To communicate the digital information between the “smart” battery and the battery adapter 100, any data communications protocol and/or specification may be used. For example, the battery adapter 100 may use the System Management Bus (SMBus) specification v.2.0 to communicate data back and forth between the “smart” battery. The SMBus specification defines a two-wire interface through which various components situated in different systems may communicate data between each other. With a smart-battery communications protocol, such as SMBus, the battery adapter 100 may provide manufacturer information, model part information, error information, and status information, as well as receive control parameters and configuration information.

The circuitry required to communicate with a “smart” battery may include an internal micro-computer and a digital interface for communicating information with an external device, such as, battery adapter 100.

FIG. 7 illustrates an exemplary battery adapter 100 operable to communicate with a smart battery 670. In addition to or in lieu of the current sensing arrangement 610, the voltage sensing arrangement 615, and the chemistry detect arrangement 635, for detecting current, voltage, and chemistry of the battery 120, respectively, the processing core may include a smart-battery interface 705 electrically and logically connected to the data bus 650, as illustrated in FIG. 7. As shown in FIG. 7, the smart-battery interface 705 includes circuitry operable to electrically and logically connect to the smart-battery 670, which includes a special data port 660 for communicating information concerning the smart-battery 670 to an external device, such as the smart-battery interface 705 of the processing core 645. The battery data port 660 includes a plurality of data lines 665 for communicating information, such as the current flowing through the smart-battery 670, the voltage across the first and second smart battery contacts 675, 680 of the smart battery 670, the chemistry of the smart-battery 670, a serial number associated with the smart battery 670, a model number associated with the smart-battery 670, the temperature of the smart-battery 670, etc. With the communicated current, voltage, and chemistry of the smart-battery 670, the processing core 645 may influence the charge profile of the smart-battery 670 in the same manner as described above.

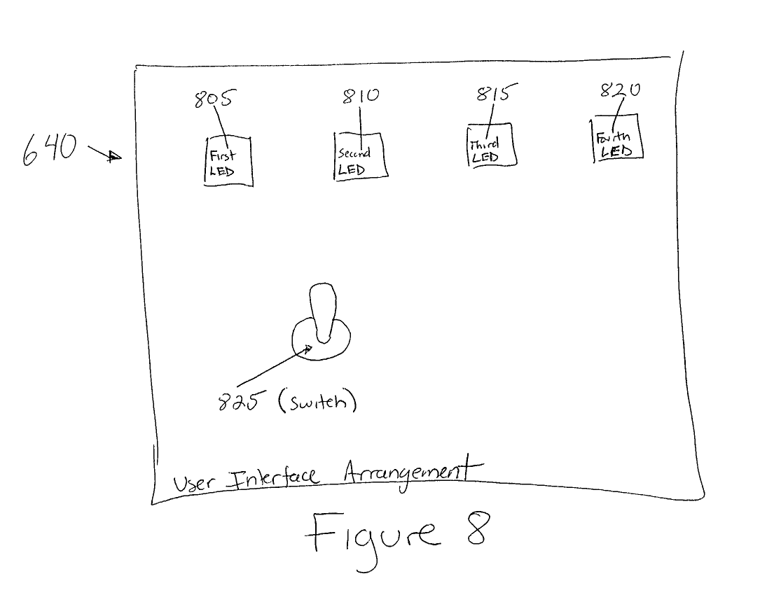

Referring now to FIG. 8, there is seen further details of the exemplary user interface arrangement 640 shown in FIGS. 106 and 7. In this embodiment, the user interface arrangement 640 includes circuitry operable to communicate data to and receive input from a user. As shown in FIG. 8, the user interface arrangement 640 includes a first, second, third, and fourth light-emitting diode (LED) 805, 810, 815, 820 and a switch 825. The first LED 805 may indicate, for example, that the battery adapter 100 is receiving power from the external power source 101. The second LED 810 may indicate, for example, whether the battery 120 is currently being charged. The third LED may indicate, for example, whether the battery 120 is fully charged. The fourth LED may indicate, for example, that the processing core 645 is initiating a condition cycle. The switch may be used, for example, to initiate a manual discharge of the battery 120 by a user of the battery adapter 100.

It should be appreciated that the user interface arrangement 640 may include any circuitry and/or arrangements operable to communicate information to and receive input from a user. For example, the user interface arrangement 640 may include a visual display device (e.g., liquid-crystal display), an audible display device, a touch-screen, a plurality of switches or buttons, etc.

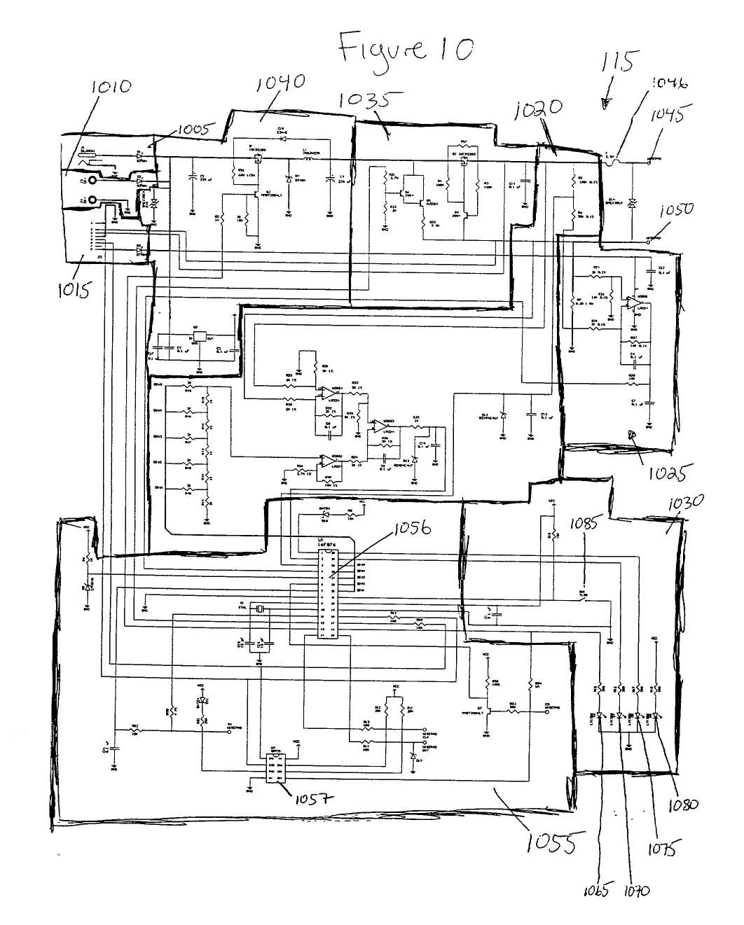

Referring now to FIG. 10, there is seen a schematic of the exemplary circuit arrangement 115 of FIGS. 1b, 5, and 6. As shown in FIG. 10, circuit arrangement 115 includes a first connection arrangement 1005, a second connection arrangement 1010, a third connection arrangement 1015, a voltage sensing arrangement 1020, a current sensing arrangement 1025, a user interface arrangement 1030, a charge/discharge arrangement 1035, a switching regulator 1040 for controlling the output voltage and current of the circuit, first and second adapter contacts 1045, 1050, and a processing core 1055.

As shown in FIG. 10, the first, second, and third connection arrangements receive power from the external power source 101 and provide the power to the battery adapter 100.

The processing core 1055 controls the charge/discharge arrangement 1035 for charging and/or discharging a battery 120 connected to the first and second adapter contacts 1045, 1050 (not shown) via a fuse 1046. For this purpose, the processing core 1055 includes a micro-computer 1056 and an electro-static discharge protection circuit 1057.

The voltage sensing arrangement 1020 and the current sensing arrangement 1025 provide the processing core 1055 with a sensed voltage and a sensed current of the battery 120, respectively, for use in influencing a charge profile, as described above.

The user interface arrangement 1030 includes first, second, third, and fourth light emitting diodes 1065, 1070, 1075, 1080 and switch 1085. The first LED 1065 may indicate, for example, that the battery adapter 100 is receiving power from the external power source 101. The second LED 1070 may indicate, for example, whether the battery 120 is currently being charged. The third LED may indicate, for example, whether the battery 120 is fully charged. The fourth LED may indicate, for example, whether the processing core 1055 is initiating a condition cycle. The switch 1085 may be used, for example, to initiate a manual discharge of the battery 120 by a user of the battery adapter 100.

The third connection arrangement 1015 includes eight conductive contacts 1, 2, 3, 4, 5, 6, 7, 8. Conductive contact 8 receives power from the external power source 101, as described above with respect to the battery analyzer 405. Conductive contact 1 and the conductive contact 4 are electrically connected to ground. Conductive contacts 5, 6 are provided for facilitating digital data communication between the processing core 1055 and an external device, such as, for example, the battery analyzer 405. Conductive contacts 2,3 are provided to permit an external device, such as, for example, the battery analyzer 405, to charge and/or discharge the battery 120.

What is claimed is:

1. A battery adapter, comprising:
a base unit;
a battery holder coupled to the base unit, the battery holder configured to receive a battery therein; and
a circuit arrangement including a first connection arrangement, a second connection arrangement, a third connection arrangement and a processing arrangement, each of the first connection arrangement, the second connection arrangement and the third connection arrangement configured to receive power from an external power source and configured to provide said power to the processing arrangement, the processing arrangement configured to at least one of charge and discharge the battery.

2. The battery adapter according to claim 1, wherein at least one of the first connection arrangement, the second connection arrangement and the third connection arrangement is configured to electrically connect to a battery analyzer.

3. The battery adapter according to claim 2, wherein the circuit arrangement is further configured to permit the battery analyzer to at least one of charge and discharge the battery.

4. The battery adapter according to claim 2, wherein the circuit arrangement is further configured to electrically and logically communicate first data to and from the battery analyzer.

5. The battery adapter according to claim 4, wherein the first data includes at least one of battery performance data and reconfiguration data.

6. The battery adapter according to claim 4, wherein the circuit arrangement is further configured to permit the battery analyzer to at least one of charge and discharge the battery.

7. The battery adapter according to claim 4, wherein the circuit arrangement includes a user communication arrangement configured to communicate at least one state of the battery adapter to a user.

8. The battery adapter according to claim 7, wherein the at least one state includes at least one of a power state, a charge state, a charge-complete state and a discharge state.

9. The battery adapter according to claim 1, wherein the circuit arrangement includes a reverse battery protection arrangement configured to disable an electrical connection between the battery and the circuit arrangement if the battery is improperly received within the battery holder, whereby the at least one of charging and discharging of the battery is disabled.

10. The battery adapter according to claim 9, wherein at least one of the first connection arrangement, the second connection arrangement and the third connection arrangement is configured to electrically connect to a battery analyzer.

11. The battery adapter according to claim 10, wherein the circuit arrangement is further configured to permit the battery analyzer to at least one of charge and discharge the battery.

12. The battery adapter according to claim 10, wherein the circuit arrangement is further configured to electrically and logically communicate first data to and from the battery analyzer.

13. The battery analyzer according to claim 12, wherein the first data includes at least one of battery performance data and reconfiguration data.

14. The battery adapter according to claim 12, wherein the circuit arrangement is further configured to permit the battery analyzer to at least one of charge and discharge the battery.

15. The battery adapter according to claim 9, wherein the circuit arrangement includes a user communication arrangement configured to communicate at least one state of the battery adapter to a user.

16. The battery adapter according to claim 15, wherein the at least one state includes at least one of a power state, a charge state, a charge-complete state and a discharge state.

17. The battery adapter according to claim 1, wherein the circuit arrangement is further configured to electrically and logically receive second data from the battery via the battery holder.

18. The battery adapter according to claim 17, wherein the second data include at least one of a voltage of the battery, a current of the battery, a serial number, a battery type, a battery model number, a chemistry of the battery, and a temperature of the battery.

19. The battery adapter according to claim 18, wherein the second data include at least one of the voltage of the battery, the current of the battery and the chemistry of the battery, the circuit arrangement configured to adjust a charge profile in accordance with at least one of the voltage of the battery, the current of the battery and the chemistry of the battery.

20. The battery adapter according to claim 17, wherein the circuit arrangement includes a reverse battery protection arrangement configured to disable an electrical connection between the battery and the circuit arrangement if the battery is improperly received within the battery holder, whereby the at least one of charging and discharging of the battery is disabled.

21. The battery adapter according to claim 17, wherein at least one of the first connection arrangement, the second connection arrangement and the third connection arrangement is configured to electrically connect to a battery analyzer.

22. The battery adapter according to claim 21, wherein the circuit arrangement is further configured to permit the battery analyzer to at least one of charge and discharge the battery.

23. The battery adapter according to claim 21, wherein the circuit arrangement is further configured to electrically and logically communicate first data to and from the battery analyzer.

24. The battery analyzer according to claim 23, wherein the first data includes at least one of battery performance data and reconfiguration data.

25. The battery adapter according to claim 23, wherein the circuit arrangement is further configured to permit the battery analyzer to at least one of charge and discharge the battery.

26. The battery adapter according to claim 17, wherein the circuit arrangement includes a user communication arrangement configured to communicate at least one state of the battery adapter to a user.

27. The battery adapter according to claim 26, wherein the at least one state includes at least one of a power state, a charge state, a charge-complete state and a discharge state.

28. The battery adapter according to claim 1, wherein the circuit arrangement is further configured to detect at least one of a voltage of the battery, a current of the battery and a chemistry of the battery, the circuit arrangement further configured to adjust a charge profile in accordance with at least one of the voltage of the battery, the current of the battery and the chemistry of the battery.

29. The battery adapter according to claim 28, wherein the circuit arrangement includes a reverse battery protection arrangement configured to disable an electrical connection between the battery and the circuit arrangement if the battery is improperly received within the battery holder, whereby the at least one of charging and discharging of the battery is disabled.

30. The battery adapter according to claim 28, wherein at least one of the first connection arrangement, the second connection arrangement and the third connection arrangement is configured to electrically connect to a battery analyzer.

31. The battery adapter according to claim 30, wherein the circuit arrangement is further configured to permit the battery analyzer to at least one of charge and discharge the battery.

32. The battery adapter according to claim 30, wherein the circuit arrangement is further configured to electrically and logically communicate first data to and from the battery analyzer.

33. The battery analyzer according to claim 32, wherein the first data includes at least one of battery performance data and reconfiguration data.

34. The battery adapter according to claim 32, wherein the circuit arrangement is further configured to permit the battery analyzer to at least one of charge and discharge the battery.

35. The battery adapter according to claim 28, wherein the circuit arrangement includes a user communication arrangement configured to communicate at least one state of the battery adapter to a user.

36. The battery adapter according to claim 35, wherein the at least one state includes at least one of a power state, a charge state, a charge-complete state and a discharge state.

37. A battery charging and discharging system, comprising:
a battery adapter including a base unit, a battery holder coupled to the base unit, the battery holder configured to receive a battery therein, and a circuit arrangement having a first connection arrangement, a second connection arrangement, a third connection arrangement and a processing arrangement, the processing arrangement configured to at least one of charge and discharge the battery; and
a docking station including at least one docking port, wherein the at least one docking port is configured to provide power to the battery adapter, and wherein at least one of the first connection arrangement, the second connection arrangement and the third connection arrangement is configured to receive power from the at least one docking port and provide said power to the processing arrangement.

38. A battery charging and discharging system, comprising:
a battery adapter including a base unit, a battery holder coupled to the base unit, the battery holder configured to receive a battery therein, and a circuit arrangement having a first connection arrangement, a second connection arrangement, a third connection arrangement and a processing arrangement, the processing arrangement configured to at least one of charge and discharge the battery; and
a battery analyzer including at least one analyzer port, wherein the at least one analyzer port is configured to provide power to the battery adapter, and wherein at least one of the first connection arrangement, the second connection arrangement and the third connection arrangement is configured to receive power from the at least one analyzer port and provide said power to the processing arrangement.

39. A battery charging and discharging system, comprising:
a battery adapter including a base unit, a battery holder coupled to the base unit, the battery holder configured to receive a battery therein, and a circuit arrangement having a first connection arrangement, a second connection arrangement, a third connection arrangement and a processing arrangement, the processing arrangement configured to at least one of charge and discharge the battery;
a docking station including at least one docking port, the at least one docking port configured to provide power to the battery adapter, at least one of the first connection arrangement, the second connection arrangement and the third connection arrangement configured to receive power from the at least one docking port and provide said power to the processing arrangement; and
a battery analyzer including at least one analyzer port, wherein the at least one analyzer port is configured to provide power to the battery adapter, and wherein at least one of the first connection arrangement, the second connection arrangement and the third connection arrangement is configured to receive power from the at least one analyzer port and provide said power to the processing arrangement.

40. A method of charging and discharging a battery, the method comprising:
providing a battery adapter including a circuit arrangement having a first connection arrangement, a second connection arrangement, and a third connection arrangement;
inserting the battery into the battery adapter;
receiving power from an external power source via one of the first connection arrangement, the second connection arrangement and the third connection arrangement; and
at least one of charging and discharging the battery using the power received from the external power source.

41. The method according to claim 40, further comprising the step of determining at least one of battery performance data and reconfiguration data concerning the battery.

42. The method according to claim 41, further comprising the step of providing the at least one of battery performance data and reconfiguration data to a device.

43. The method according to claim 41, wherein the battery performance data include at least one of the voltage of the battery, the current of the battery and the chemistry of the battery,

44. The method according to claim 41, further comprising the step of adjusting a charge profile in accordance with at least one of the voltage of the battery, the current of the battery and the chemistry of the battery.
